(19) United States
(12) Patent Application Publication
(10) Pub. No.: US 2023/0013684 A1
(43) Pub. Date: Jan. 19, 2023

(54) CALCULATING ENTITY LOCATION ASSIGNMENTS WITHIN AN ENVIRONMENT

(71) Applicant: International Business Machines Corporation, Armonk, NY (US)

(72) Inventors: Nitin Ramchandani, San Jose, CA (US); Aly Megahed, San Jose, CA (US); Ahmed Nazeem, Fremont, CA (US); Peifeng Yin, San Jose, CA (US)

(21) Appl. No.: 17/370,897

(22) Filed: Jul. 8, 2021

(51) Int. Cl. G06Q 10/10; G06Q 10/04; G06Q 10/06

(52) U.S. Cl. CPC G06Q 10/103; G06Q 10/04; G06Q 10/06313

(57) ABSTRACT

A computer-implemented method according to one embodiment includes receiving input data for a plurality of entities and locations; defining constraints for a group-based allocation model; mapping a distance matrix to a plurality of distance levels to obtain a distance-level formulation; defining a group-level objective function for the group-based allocation model; applying the distance-level formulation to the group-level objective function; solving the group-based allocation model to obtain a group-level assignment; and mapping the group-level assignment to an entity-level assignment.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE(S): [“The Office Space Allocation Problem: A Novel and More Efficient Group-Based Formulation and Exact Solution Algorithms,” Nitin Ramchandani, Aly Megahed, German Flores, Peifing Yin, and Ahmed Nazeem, Nov. 8, 2020].

### BACKGROUND

The present invention relates to entity location assignment calculation, and more specifically, this invention relates to assignment calculation model optimization.

Optimizing the location of entities within an environment may provide many benefits. For example, optimizing a location of employees within available office space may increase productivity, collaboration and employee happiness, decrease unnecessary digital communication, etc. However, entity location optimization is far too complicated to be performed by a human mind alone, and current solutions implemented by hardware computing devices implement a heuristic approach that does not consider environmental constraints and results in sub-optimal solutions when a large number of employees are considered. There is therefore a need to improve the calculation of entity location assignments within an environment.

### SUMMARY

A computer-implemented method according to one embodiment includes receiving input data for a plurality of entities and locations; defining constraints for a group-based allocation model; mapping a distance matrix to a plurality of distance levels to obtain a distance-level formulation; defining a group-level objective function for the group-based allocation model; applying the distance-level formulation to the group-level objective function; solving the group-based allocation model to obtain a group-level assignment; and mapping the group-level assignment to an entity-level assignment.

According to another embodiment, a computer program product includes one or more computer readable storage media, and program instructions collectively stored on the one or more computer readable storage media, the program instructions including instructions configured to cause one or more processors to perform a method including receiving, by the one or more processors, input data for a plurality of entities and locations; defining, by the one or more processors, constraints for a group-based allocation model; mapping, by the one or more processors, a distance matrix to a plurality of distance levels to obtain a distance-level formulation; defining, by the one or more processors, a group-level objective function for the group-based allocation model; applying, by the one or more processors, the distance-level formulation to the group-level objective function; solving, by the one or more processors, the group-based allocation model to obtain a group-level assignment; and mapping, by the one or more processors, the group-level assignment to an entity-level assignment.

According to another embodiment, a system includes a processor; and logic integrated with the processor, executable by the processor, or integrated with and executable by the processor, where the logic is configured to receive input data for a plurality of entities and locations; define constraints for a group-based allocation model; map a distance matrix to a plurality of distance levels to obtain a distance-level formulation; define a group-level objective function for the group-based allocation model; apply the distance-level formulation to the group-level objective function; solve the group-based allocation model to obtain a group-level assignment; and map the group-level assignment to an entity-level assignment.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment of the present invention.

FIG. 2 shows a representative hardware environment that may be associated with the servers and/or clients of FIG. 1, in accordance with one embodiment of the present invention.

FIG. 3 illustrates a tiered data storage system in accordance with one embodiment of the present invention.

FIG. 4 illustrates a method for calculating entity location assignments within an environment, in accordance with one embodiment of the present invention.

FIG. 5 illustrates an exemplary group-based entity location allocation environment, in accordance with one embodiment of the present invention.

FIG. 6 illustrates a method for obtaining entity-level location assignments utilizing a group-based allocation model, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for calculating entity location assignments within an environment.

In one general embodiment, a computer-implemented method includes receiving input data for a plurality of entities and locations; defining constraints for a group-based allocation model; mapping a distance matrix to a plurality of distance levels to obtain a distance-level formulation; defining a group-level objective function for the group-based allocation model; applying the distance-level formulation to the group-level objective function; solving the group-based allocation model to obtain a group-level assignment; and mapping the group-level assignment to an entity-level assignment.

In another general embodiment, a computer program product includes one or more computer readable storage media, and program instructions collectively stored on the one or more computer readable storage media, the program instructions including instructions configured to cause one or more processors to perform a method including receiving, by the one or more processors, input data for a plurality of entities and locations; defining, by the one or more processors, constraints for a group-based allocation model; mapping, by the one or more processors, a distance matrix to a plurality of distance levels to obtain a distance-level formulation; defining, by the one or more processors, a group-level objective function for the group-based allocation model; applying, by the one or more processors, the distance-level formulation to the group-level objective function; solving, by the one or more processors, the group-based allocation model to obtain a group-level assignment; and mapping, by the one or more processors, the group-level assignment to an entity-level assignment.

In another general embodiment, a system includes a processor; and logic integrated with the processor, executable by the processor, or integrated with and executable by the processor, where the logic is configured to receive input data for a plurality of entities and locations; define constraints for a group-based allocation model; map a distance matrix to a plurality of distance levels to obtain a distance-level formulation; define a group-level objective function for the group-based allocation model; apply the distance-level formulation to the group-level objective function; solve the group-based allocation model to obtain a group-level assignment; and map the group-level assignment to an entity-level assignment.

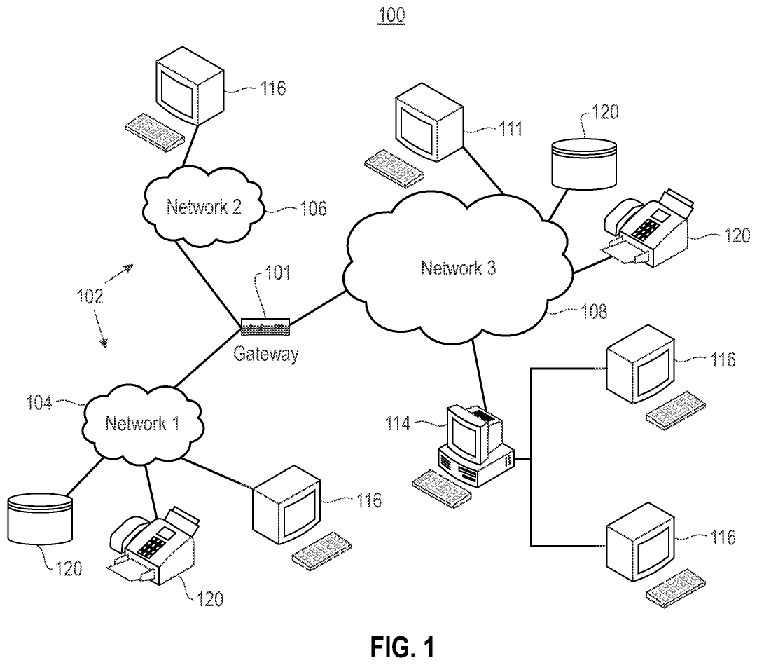

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

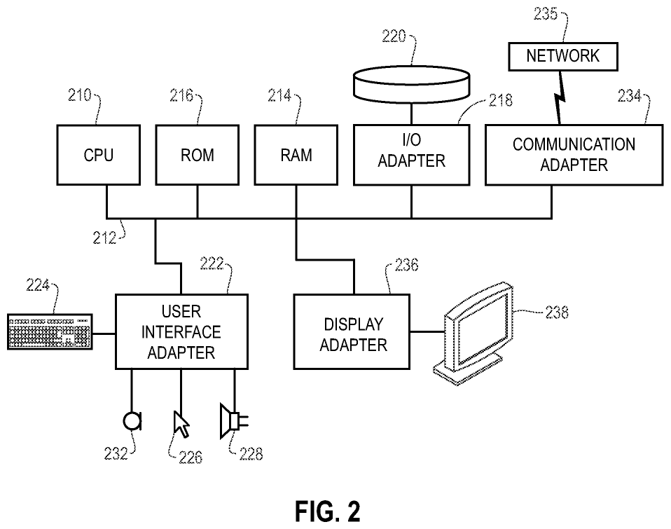

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

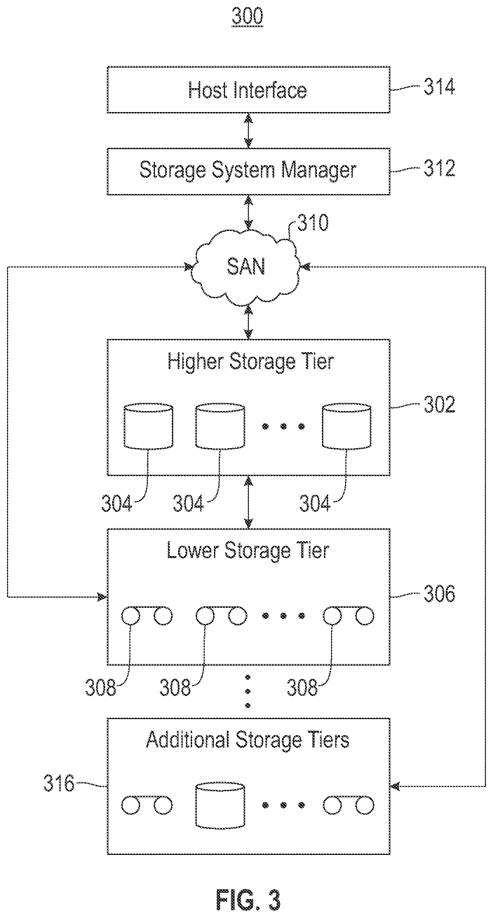

Now referring to FIG. 3, a storage system 300 is shown according to one embodiment. Note that some of the elements shown in FIG. 3 may be implemented as hardware and/or software, according to various embodiments. The storage system 300 may include a storage system manager 312 for communicating with a plurality of media on at least one higher storage tier 302 and at least one lower storage tier 306. The higher storage tier(s) 302 preferably may include one or more random access and/or direct access media 304, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 306 may preferably include one or more lower performing storage media 308, including sequential access media such as magnetic tape in tape drives and/or optical media, slower accessing HDDs, slower accessing SSDs, etc., and/or others noted herein or known in the art. One or more additional storage tiers 316 may include any combination of storage memory media as desired by a designer of the system 300. Also, any of the higher storage tiers 302 and/or the lower storage tiers 306 may include some combination of storage devices and/or storage media.

The storage system manager 312 may communicate with the storage media 304, 308 on the higher storage tier(s) 302 and lower storage tier(s) 306 through a network 310, such as a storage area network (SAN), as shown in FIG. 3, or some other suitable network type. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 300 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 302, may include a majority of SSD storage media for storing data in a higher performing storage environment, and remaining storage tiers, including lower storage tier 306 and additional storage tiers 316 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the embodiments presented herein.

According to some embodiments, the storage system (such as 300) may include logic configured to receive a request to open a data set, logic configured to determine if the requested data set is stored to a lower storage tier 306 of a tiered data storage system 300 in multiple associated portions, logic configured to move each associated portion of the requested data set to a higher storage tier 302 of the tiered data storage system 300, and logic configured to assemble the requested data set on the higher storage tier 302 of the tiered data storage system 300 from the associated portions.

Of course, this logic may be implemented as a method on any device and/or system or as a computer program product, according to various embodiments.

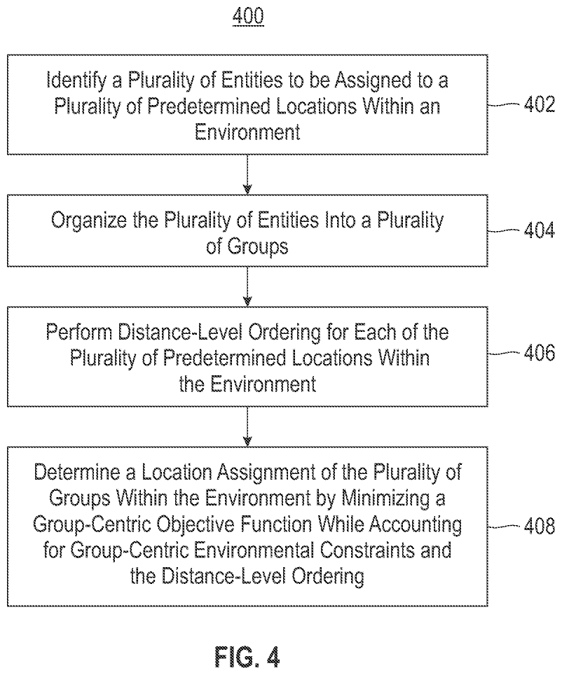

Now referring to FIG. 4, a flowchart of a method 400 for training a predictive model is shown according to one embodiment. The method 400 may be performed in accordance with the present invention in any of the environments depicted in FIGS. 1-3 and 5, among others, in various embodiments. Of course, greater or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a plurality of entities to be assigned to a plurality of predetermined locations within an environment are identified. In one embodiment, one or more of the plurality of entities may include an individual (e.g., a person, an employee of a predetermined business, etc.). In another embodiment, one or more of the plurality of entities may include a device (e.g., an instance of manufacturing equipment, an electronic device, etc.).

Additionally, in one embodiment, the environment may include a predetermined geographical location, area, etc. For example, the environment may include all or a portion of a commercial real estate building, all or a portion of a manufacturing facility, an outdoor event location, etc. In another embodiment, a description of the environment, as well as all predetermined constraints for the environment, may also be identified.

Further, in one embodiment, the predetermined locations may include predetermined geographical portions of the predetermined geographical location, area, etc. For example, the predetermined locations may include all offices within all or a portion of a commercial real estate building, all stations within all or a portion of a manufacturing facility, a plurality of booths at an outdoor event location, etc. In another embodiment, assigning an entity to a predetermined location may include associating an identifier of the entity with an identifier of the predetermined location.

For example, each of the predetermined locations within an environment may be represented as objects (e.g., within an environment map, within a table representing the environment, etc.). In another example, assigning the entity to the predetermined location may include adding information associated with the entity (e.g., an entity ID, etc.) as metadata to the object representing the predetermined location. In yet another example, assigning the entity to the predetermined location may include linking information associated with the entity (e.g., an entity ID representing the entity within a first ID table, etc.) to information associated with the predetermined location (e.g., a predetermined location ID representing the predetermined location within a second ID table, etc.). For instance, the information may be linked utilizing a pointer, etc.

Further still, in one embodiment, the plurality of entities may be currently assigned to initial locations within the environment, and a request may be received to rearrange the plurality of entities within the predetermined locations within the environment in a more efficient manner. In another embodiment, the plurality of entities may not be currently assigned to any locations within the environment, and a request may be received to assign the plurality of entities to the predetermined locations within the environment in the most efficient manner.

Also, method 400 may proceed with operation 404, where the plurality of entities is organized into a plurality of groups. In one embodiment, each of the plurality of groups may include two or more entities. In another embodiment, a number of the plurality of groups may be less than a number of the plurality of entities. In yet another embodiment, the plurality of entities may be organized into groups based on one or more predetermined criteria.

In addition, in one embodiment, each of the entities may have associated metadata (e.g., indicating a project that the entity is associated with, a division of a company that the entity is associated with, a type of work/product that the entity is associated with, etc.). In another embodiment, entities sharing a predetermined instance of metadata and/or a predetermined number of instances of metadata may be grouped together to form a single group.

For example, all employees of a company that are currently working on a predetermined project may have an identifier of that predetermined project associated with their employee ID. In another example, all employees having an employee ID that is associated with the same project identifier may be grouped together to form a group (e.g., a group with an identifier matching the project identifier, etc.).

Also, method 400 may proceed with operation 406, where distance-level ordering is performed for each of the plurality of predetermined locations within the environment. In one embodiment, performing distance-level ordering may include converting and/or translating a first unit of distance measure (e.g., meter level distances, etc.) to a user-defined level (e.g., a distance between the predetermined locations such as floors, buildings or a combination of these).

Furthermore, method 400 may proceed with operation 408, where a location assignment of the plurality of groups within the environment is determined by minimizing a group-centric objective function while accounting for group-centric environmental constraints and the distance-level ordering. In one embodiment, the group-centric objective function, group-centric environmental constraints, and group-level distance granularity may be created by updating an entity-centric objective function, entity-centric environmental constraints, and the distance-level ordering. For example, variables and constraints associated with individual entities within the entity-centric objective function, entity-centric environmental constraints, and the distance-level ordering may be replaced with variables and constraints associated with the plurality of created groups.

Further still, in one embodiment, the entity-centric objective function and entity-centric environmental constraints may be included within an entity-centric relocation method. In another embodiment, the updating may occur while reformulating the entity-centric relocation method to create a group-centric relocation method. In yet another embodiment, the group-centric objective function may calculate a value indicative of an efficiency of group location assignments within the environment.

Also, in one embodiment, the value calculated utilizing the group-centric objective function may include the following: (distance)— (bias)+(moving cost). For example, the distance value may include a distance between groups within the environment. In another example, the bias value may include one or more predetermined location preferences for groups within the environment. In yet another example, the moving cost value may include a cost to move a group from an initial location to a new location. In still another example, minimizing the value calculated utilizing the group-centric objective function may optimize the location of groups within the environment.

Additionally, in one embodiment, the group-centric environmental constraints may include predetermined preferences for the groups within the environment. For example, the group-centric environmental constraints may indicate that only certain groups may be assigned to certain locations within the environment (e.g., within certain floors, etc.). In another example, the group-centric environmental constraints may indicate that a maximum number of entities may be assigned to certain locations within the environment (e.g., within certain floors, etc.). In yet another example, the group-centric environmental constraints may indicate one or more predetermined locations for one or more predetermined groups.

Also, in one embodiment, input into the group-centric objective function may include one or more matrices. For example, the input may include a distance matrix indicating a distance between locations within the environment (where the locations may include offices, floors, buildings, etc.). In another example, the input may include a moving cost matrix indicating a moving cost for groups between locations within the environment. In yet another example, the input may include an eligibility matrix that includes an eligibility of employee in each group for predetermined locations within the environment. In still another example, the input may include a group matrix indicating group-entity relationships. In another example, the input may include a current assignment matrix indicating a location where the groups are currently assigned. These matrices may be predetermined.

Further still, in one embodiment, an entity location assignment for each of the plurality of entities within their respective group location assignments may then be determined by minimizing the entity-centric objective function while accounting for entity-centric environmental constraints and the distance-level ordering. In another embodiment, the value calculated utilizing the entity-centric objective function may include the following: (distance)−(bias)+(moving cost).

For example, the distance value may include a distance between entities within the environment. In another example, the bias value may include one or more predetermined location preferences for specific entities within the environment. In yet another example, the moving cost value may include a cost to move an entity from an initial location to a new location. Minimizing the value calculated utilizing the entity-centric objective function may optimize the location of entities within a group.

Also, in one embodiment, the entity-centric environmental constraints may include predetermined preferences for the entities within the group. For example, the entity-centric environmental constraints may indicate that only certain entities may be assigned to certain locations within the environment (e.g., within certain offices within a single floor, etc.). In another example, the entity-centric environmental constraints may indicate that a maximum number of entities may be assigned to certain locations within the environment (e.g., within certain offices within a single floor, etc.). In yet another example, the entity-centric environmental constraints may indicate that each entity needs to have an associated location assignment. In still another example, the entity-centric environmental constraints may indicate one or more predetermined locations for one or more predetermined entities.

Also, in one embodiment, the entity-centric environmental constraints may include one or more matrices. For example, the entity-centric environmental constraints may include a distance matrix indicating a distance between locations within the environment (where the locations may include offices, floors, buildings, etc.). In another example, the entity-centric environmental constraints may include a moving cost matrix indicating a moving cost for entities between locations within the environment. In yet another example, the entity-centric environmental constraints may include an eligibility matrix that includes an eligibility of each entity for predetermined locations within the environment. In another example, the entity-centric environmental constraints may include a current assignment matrix indicating a location where the entities are currently assigned. These matrices may be predetermined.

Also, in one embodiment, a group center location may be selected for each group, and a distance from the group center location may be minimized when minimizing the entity-centric objective function. This may include minimizing a distance from the group center when minimizing an entity-centric objective function to determine an entity location assignment for each of the plurality of entities within their respective group location assignments.

Furthermore, in one embodiment, a current location of each of the plurality of entities within the environment may be considered when determining entity location assignments. More specifically, a distance from the current location of each of the plurality of entities and the new location assignment for each of the plurality of entities may be minimized when calculating the new location assignment. In another embodiment, communication between groups within the environment may be considered when determining group location assignments. More specifically, a first distance between groups that communicate a first amount (e.g., during a predetermined time period) may be minimized so that the first distance is smaller than a second distance between groups that communicate a second amount (e.g., during the same time period) that is less than the first amount. In yet another embodiment, location assignments may be determined according to a predetermined schedule, when one or more thresholds (e.g., maximum telecommunications usage thresholds within a company) are met, etc.

Further still, in one embodiment, all or some of the above operations may be performed utilizing one or more computing devices. For example, the computing devices may include a distributed computing environment, a cloud computing environment, one or more neural networks, one or more servers, etc.

Also, in one embodiment, the location assignment of each of the plurality of entities may be implemented within their respective group. For example, information indicating a predetermined location determined for an entity (e.g., office, booth, geographical area, etc.) may be associated with an identifier of that entity. For example, the determined location for an entity may be saved as metadata for the entity. In another embodiment, one or more messages (e.g., emails, etc.) may be sent to each entity indicating a location assignment determined for that entity.

In this way, group location assignments may be made first, and entity location assignments may then be made within those group location assignments, all while addressing environmental constraints and preset preferences and adjustment granularities. This may reduce a complexity of location assignments for the entities, and may reduce an amount of hardware processing needed to determine such location assignments, which may improve a performance of computing hardware implementing such location assignments.

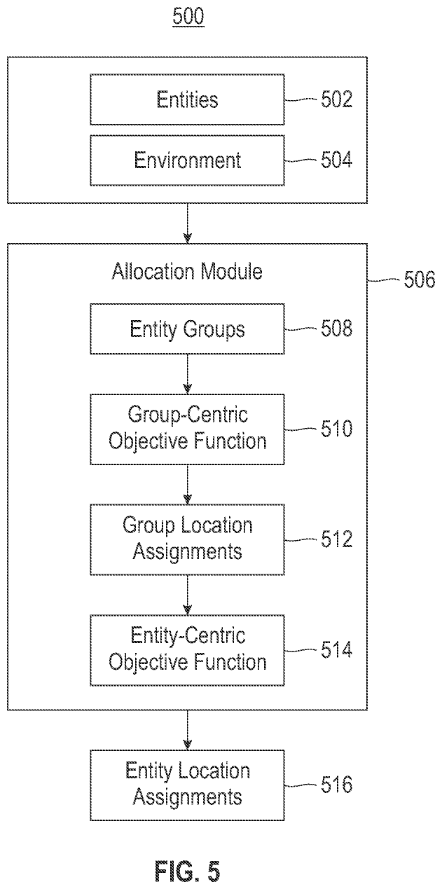

FIG. 5 illustrates an exemplary group-based entity location allocation environment 500, according to one exemplary embodiment. As shown, an identification of a plurality of entities 502 as well as a description of an associated environment 504 is received at an allocation module 506.

Additionally, the allocation module 506 creates a plurality of entity groups 508, utilizing the plurality of entities 502. These entity groups 508 may be created utilizing group information provided as a matrix within the description of the associated environment 504. These entity groups 508 are input by the allocation module 506 into a group-centric objective function 510, which is minimized while accounting for group-centric environmental constraints (derived from the description of the associated environment 504) and a group-level distance granularity to produce group location assignments 512.

In one embodiment, the allocation module 506 may include a distributed computing environment, a cloud computing environment, one or more neural networks, one or more servers, etc.

Further, the group location assignments 512 are input by the allocation module 506 into an entity-centric objective function 514, which is minimized while accounting for entity-centric environmental constraints and an entity-level distance granularity to produce entity location assignments 516. These entity location assignments 516 may then be saved in association with the plurality of entities 502.

In this way, the allocation module 506 may quickly and efficiently calculate optimal entity placement within an environment, while considering all environmental constraints.

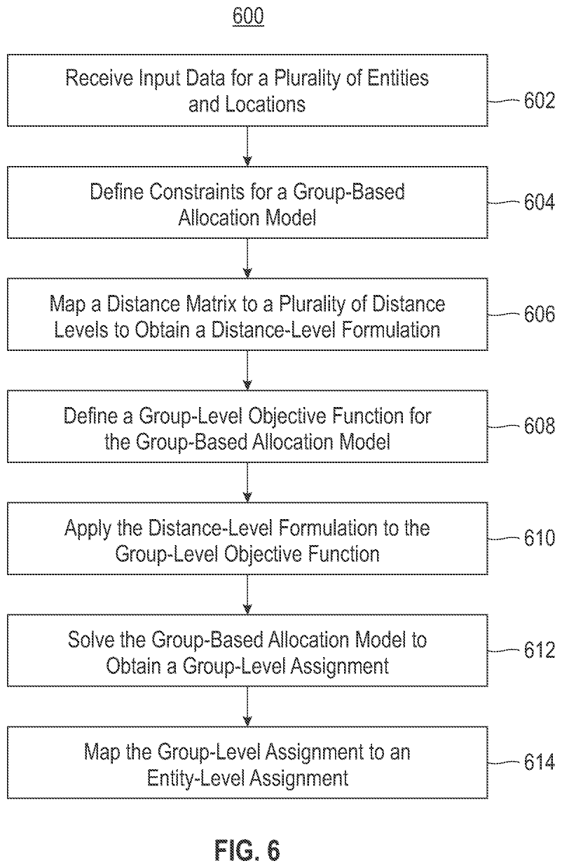

Now referring to FIG. 6, a flowchart of a method 600 for obtaining entity-level location assignments utilizing a group-based allocation model is shown according to one embodiment. The method 600 may be performed in accordance with the present invention in any of the environments depicted in FIGS. 1-3 and 5, among others, in various embodiments. Of course, greater or fewer operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where input data for a plurality of entities and locations is received. In one embodiment, the entities may include employees, and the locations may include offices. Additionally, method 600 may proceed with operation 604, where constraints are defined for a group-based allocation model. In one embodiment, the group-based allocation model may be formulated at a group level instead of an entity level, thereby increasing a computational tractability of the group-based allocation model. In another embodiment, the group-based allocation model may incorporate a distance level, thereby reducing a number of quadratic terms within the group-based allocation model.

Also, in one embodiment, the constraints may be modified within the group-based allocation model, constraints mapping groups to specific locations including offices, meeting rooms, and lab rooms may be added to the group-based allocation model, and constraints indicating entity-location eligibility constraints may be added to the group-based allocation model.

Further, method 600 may proceed with operation 606, where a distance matrix is mapped to a plurality of distance levels to obtain a distance-level formulation. Further still, method 600 may proceed with operation 608, where a group-level objective function is defined for the group-based allocation model. Also, method 600 may proceed with operation 610, where the distance-level formulation is applied to the group-level objective function.

In addition, method 600 may proceed with operation 612, where the group-based allocation model is solved to obtain a group-level assignment. Furthermore, method 600 may proceed with operation 614, where the group-level assignment is mapped to an entity-level assignment. For example, a group-level solution may be mapped to an entity-level solution.

Also, in one embodiment, a group center may be selected for each group, and distances between locations may be calculated utilizing the group center instead of pairwise distances between locations. In another embodiment, the utilization of the group center may increase a computational tractability of the group-based allocation model.

Large-Scale Group Office Allocation

When implementing office assignments, a user may have different requirements to satisfy diversified application scenarios. For example, some employee-office assignments may need to be fixed, some employees/offices may need to be excluded for re-assignment, and different assignments may result in different costs, etc. Therefore, the user side needs a flexible interface to configure the optimization constraint. On the other hand, the optimization model requires a relatively fixed problem. A data processing module may be provided as a solution.

In general, the data processing takes the raw data as input and outputs it in format that matches the definition of the optimization model. Particularly, three interfaces, (exclusion, distance/cost configuration and eligibility definition) are provided to the user for customizing the constraints. The exclusion interface enables the user to exclude particular people/office from optimization. In some application scenarios, particular person-office assignments (e.g., the director and his/her specific office) may need to be fixed and thus specific employee/office pairs may be excluded. Also, some offices may be reserved for particular usage (e.g., as a public collaboration working space) and may not be assigned to an individual. Finally, some people may transfer to other departments at a predetermined time and thus their current spots may be empty and they may no longer need to be assigned an office.

To satisfy these potential requests, the exclusion configuration can be used to filter the raw sets of employees and offices. The distance/cost interface allows the measurement of the distance and moving cost between each pair of offices. In a large organization, the distance between pairs of offices may be different, depending on the locations. Also, the cost of moving from one office to another may differ from case to case, due to both the building facility (e.g., the presence of a large elevator) and the employee's situation (e.g., a user may have many heavy personal assets, nothing but light documents, etc.).

To simplify the configuration process, three levels of distance/cost may be provided—building level, floor level, and room level. The building level captures the base distance and moving cost between two buildings. It is triggered when the pair of offices are located in two different buildings. The floor level handles the case where two targeted offices are in different floors. Finally, the room level measures the minor distance/cost based on the room number.

Generally, offices are referenced by office numbers and neighboring offices tend to have a close number sequence. Therefore, the last three number digits may be used to measure a distance/cost between two offices that are in the same building and floor. In summary, the distance may include the sum of building-level, floor level and room level distance, each of which is defined by a user. The moving cost has the same computation rule while the user provides a separate configuration.

Finally, the eligibility definition offers a way to define which type of employee is eligible for which type of office. In practice, different offices may have different characteristics, such as size, sound insulation, with/without window, etc. These differences may be a result of the building plan. When assigning an employee to an office, these factors may be taken into consideration. For example, for people who have frequent meeting with others (e.g., project managers), a shared office or cubicle may not be assigned since it would make it inconvenient to talk/would disturb others. Furthermore, some company policies provide distinguished employees with a single office or gives them higher priority to occupy offices that have a better view. In this configuration, the user defines all employee types and office types. For each employee-office type pair, the user needs to indicate whether the particular employee type can reside in that office.

In summary, after data processing, there are five separate files, all in matrix format, feeding into the optimization model, as follows:
Distance matrix. This data shows the distance for each pair of offices based on the user-defined three-level distance rule. Each row and column represents an office and the diagonal element is zero.
Moving cost matrix. Similar to the distance matrix, the moving cost matrix shows the moving cost of each pair of offices based on the user-defined three-level cost rule. Again, the diagonal elements are all zero.
Eligibility matrix. This is a binary matrix where each row represents an employee and each column an office. The element value is either 1 (eligible) or 0 (not eligible), suggesting the eligibility of corresponding employee-office pair.
Employee-group matrix. This binary matrix consists of all employees (rows) and groups (columns). It indicates the belongs of the employee to the particular group. Based on this matrix, the optimization model can calculate the within-group distance given an assignment scheme.
Current assignment matrix. This binary matrix shows the current office assignment. Particularly each row represents an employee and each column represents an office. With this matrix, the optimization model can calculate the moving cost when evaluating a candidate new office assignment.

Model Formulation Parameters

Let E be the set of employees, let OC be the set of offices, and let G be the set of groups.
Let E(g) denote the set of employees that belong to group g
Let MtnRm be the set of indices of the meeting rooms, and let OC′=OC U MtnRm
Given a pair of ofices j and j′, let d(j, j′) denote the distance between them.
Let MC denote the moving cost associated with relocating any employee from their current office
For an employee i and office j, let A be the eligibility matrix such that A(i, j)=1 if employee i is eligible to occupy office j, and A(i, j)=0 otherwise.
For a group g, let NMR(g) be the number of meeting rooms that should be assigned to group g.
Let CO be the current employee-office assignment matrix such that CO(i, j)=1 if office j is currently assigned to employee i, and CO(i, j)=0 otherwise
Let FE be the set of employees that cannot be relocated
Let FO be the set of offices that cannot be reassigned.
Given employee i and office j, let EB(i, j) denote the incentive/penalty of assigning office j to employee i.
Let Grp(i) denote the group of employee i.

Variables
Let xᵢⱼ be a binary variable that equals to 1 if and only if (iff) employee i is assigned to office j
Let ygj be a binary variable that equals to 1 iff group g is assigned to meeting room j

The objective function contains 3 parts:

minimize Distance−Bias+MovingCost (1)
The Distance portion of the objective function includes the sum of the inter-office distances between employee of the same group.
The Bias portion of the objective includes a predetermined preference to assign certain employee to specific offices.
The MovingCost portion of the objective includes an amount of relocation decisions to be made by the model.

$$Bias = {\sum }_{i ∈ E , j ∈ OC} E B ( i , j ) \cdot {x}_{ij} \qquad ( 2 )$$

The bias is simply the sum of incentives/penalties associated with the assignment decision

$$Moving Cost = MC \cdot {\sum }_{i ∈ E , j ∈ OC : CO [ i , j ] = 0} {x}_{ij} \qquad ( 3 )$$

The total moving cost is simply the number of relocation decisions multiplied by the individual moving cost.

$$Distance = {\sum }_{j , {j}^{′} ∈ OC : j < {j}^{′}} d ( j , {j}^{′} ) \cdot {\sum }_{i , {i}^{′} ∈ E : {i}^{′} \neq i , {i}^{′} ∈ Grp ( i )} {x}_{ij} \cdot {x}_{{i}^{′} {j}^{′}} + {\sum }_{k , {k}^{′} ∈ MtnRm , k < {k}^{′}} d ( k , {k}^{′} ) {\cdot \sum }_{g ∈ G} {y}_{g k} \cdot {y}_{{gk}^{′}} + {\sum }_{j ∈ O C , k ∈ MtnRm} d ( j , k ) {\sum }_{g ∈ G , i ∈ E ( g )} {x}_{ij} \cdot {y}_{g k} \qquad ( 4 )$$

The sum of the inter-office distances contains 3 terms:

1. The distance between each pair of offices that got assigned to employees that belong to the same groups.

2. The distance between the meeting rooms that got assigned to the same group.

3. The distance between each pair of office and meeting room that got assigned to the same group.

$$∀ j ∈ M t nRm : {\sum }_{g ∈ G} {y}_{g j} \leq 1 \qquad ( 5 )$$

Each meeting room should be assigned to at most one group.

$$∀ j ∈ OC : {\sum }_{i ∈ E} {x}_{ij} \leq 1 \qquad ( 6 )$$

Each office can be occupied by at most 1 employee.

$$∀ i ∈ E : {\sum }_{j ∈ O C} {x}_{i j} = 1 \qquad ( 7 )$$

Each employee should be assigned to one office.

$$∀ g ∈ G : {\sum }_{j ∈ MtnRm} {y}_{g j} = N M R ( g ) \qquad ( 8 )$$

Each group should get the specified number of meeting rooms.

$$∀ i ∈ E : {\sum }_{j ∈ OC : A ( i , j ) = 0} {x}_{ij} = 0 \qquad ( 9 )$$

An employee cannot be assigned to an office if he is not eligible to.

∀j∈FO,i∈E s.t. CO(i,j)=1:xᵢⱼ=1 (10)

∀i∈FE,j∈OC s.t. CO(i,j)=1:xᵢⱼ=1 (11)

Equations 10 and 11 implement the requirement that some office assignments might need to be fixed by the business.

The major complexity of the model is in the quadratic terms in Equation 4. This equation contains [symbol] (|OC|²·|E|²) quadratic terms. For a facility that has about 500 office and 500 employees, this equation will contain about 62 billion quadratic terms. A simplification is therefore desirable.

Reformulation

Group Formulation

The inter-office distances between employees of the same group are agnostic to the specific employee assigned and this metric depends only on the office to group assignment. In other words, if offices j1 and j2 were assigned to employees i1 and i2 respectively, then inter-distance penalty will be d(j1, j2) if i1 and i2 belong to the same group or it will be zero if they belong to different groups. Thus, the group membership of i1 and i2 is the decisive factor whether d(j1, j2) will be added to the penalty or not, but the specific choice of i1 and i2 does not matter as long as their group membership is fixed.

Based on the intuition in the previous paragraph, the domain is modified as follows.

1. Equation 5 will be extended to cover all offices.

$$∀ j ∈ O {C}^{l} : {\sum }_{g ∈ G} {y}_{g j} \leq 1 \qquad ( 12 )$$

2. Equation 4 will be reformulated to be based on the group to office assignment rather than the employee to office assignment.

$$Distance = {\sum }_{j , {j}^{′} ∈ {OC}^{′} : j < {j}^{′}} d ( j , {j}^{′} ) \cdot {\sum }_{g ∈ G} {y}_{g j} \cdot {y}_{{gj}^{′}} \qquad ( 13 )$$

3. Equation 6 is reformulated to link the office-group assignment variable ygj to the office-employee assignment variable xij. That is, if an office was assigned to a group, ygj=1, then one employee that belongs to the group g will occupy this office. On the other hand, if an office is not assigned to a group, ygj=0, then none of the employees that belong to the group g can occupy the office.

$$∀ j ∈ O C , ∀ g ∈ G : {\sum }_{i ∈ E ( g )} {x}_{ij} = {y}_{g j} \qquad ( 14 )$$

The quadratic terms in Equation 13 can be linearized in a standard way as follows:

$$∀ j , {j}^{′} ∈ {OC}^{′} : j < {j}^{′} , ∀ g ∈ G : {Y}_{g , j , {j}^{′}} \geq {y}_{gj} + {y}_{{gj}^{′}} - 1 \qquad ( 15 )$$

$$Distance = {\sum }_{j , {j}^{′} ∈ {OC}^{′} : j < {j}^{′}} d ( j , {j}^{′} ) \cdot {\sum }_{g ∈ G} {y}_{g , j , {j}^{′}} \qquad ( 16 )$$

The inter-office distances cost captures the distance between each pair of offices and/or meeting rooms if they were assigned to the same group. The number of quadratic terms are now in the order of [symbol] (|OC′|²·|G|) quadratic terms. After the linearization proposed in Equations 15-16, the number of constraints needed to define the variables Yg,j,j′ is of order [symbol] (|OC′|²·|G|). Practically, the number of groups may be smaller than the number of employees. For example, if the number of offices is 500, the number of employees is 500, and the number of groups is 10, then number of quadratic terms in the formulation proposed in this section is 2.5 million terms.

Distance Level Ordering
Let D be the set of all possible distance values between offices.
Let zg,j,d be an integer variable that counts the number of offices with index j′>j assigned to group g that are within distance d from office j if office j is assigned to group g.

Equation 13 will then be replaced with the following equations:

$$Distance = {\sum }_{g ∈ G , j ∈ {OC}^{′} , d ∈ D} d \cdot {𝓏}_{g , j , d} \qquad ( 17 )$$

$$∀ g ∈ G , j ∈ {OC}^{′} , d ∈ D : M \cdot {y}_{gj} + {\sum }_{{j}^{′} ∈ OC , {j}^{′} > j : d ( j , {j}^{′} ) = d} {y}_{g , {j}^{′}} - M + \leq {𝓏}_{g , j , d} \qquad ( 18 )$$

If ygj=1, Equation 18 reduces to:

Σ_{j′∈OC,j′>jLd(j,j′)=d}y_{g,j′}≤z_{g,j,d}. (19)

Therefore, zg,j,d is equal to the total number of offices with index j0>j assigned to group g that are distance d from office j. On the other hand, if ygj=0, zg,j,d is free, and is set to 0 due to Equation 17.

In practice, the distance between offices will not matter at the meter level, but it would rather matter at the building/floor level. Hence, the cardinality of the set D is usually much smaller than that of the set OC′. The number of constraints needed to define zg,j,d in Equation 16 is of the order [symbol] (|D|·|OC′|·|G|). For example, if the number of offices is 500, the number of employees is 500, and the number of groups is 10, the number of buildings is 5, and the number of floors is 3, and hence IDI=15, then then number of constraints needed to define zg,j,d is 75,000 terms. This number is significantly smaller than the number derived utilizing Equation 13.

Groups Centers Approximation
Let ctr_{gj} be a binary variable that equals to 1 iff the center of group g is assigned to office j.
Let wg,j,d be an integer variable that counts the number of offices assigned to group g that are within distance d from office j if office j is chosen as the center of group g.

One goal of this approximation is to assign an office to each group to act as its center, then try to minimize the distances of the offices assigned to each group from the group center. Thus, instead of minimizing the pairwise distance between offices within each group, the proposed approximation minimizes the distance between each group office and the group center.

To perform the proposed approximation, Equation 13 will be replaced with the following equations:

$$Distance = {\sum }_{g ∈ G , j ∈ {OC}^{′} , d ∈ D} d \cdot {w}_{g , j , d} \qquad ( 20 )$$

$$∀ g ∈ Group : {\sum }_{j ∈ {OC}^{′}} {ctr}_{gj} = 1 \qquad ( 21 )$$

Each group should have exactly one center office:

$$∀ g ∈ G , j ∈ {OC}^{′} , d ∈ D : M \cdot {ctr}_{g j} + {\sum }_{{j}^{′} ∈ OC : d ( j , {j}^{′} ) = d} {y}_{g , {j}^{′}} - M \leq {w}_{g , j , d} \qquad ( 22 )$$

If ctrgj=1, Equation 22 reduces to:

Σ_{j′∈OC,j′>j:d(j,j′)=d}y_{g,j′}≤w_{g,j,d} (23)

As a result, wg,j,d is equal to the total number of offices with index j0>j assigned to group g that are distance d from office j. On the other hand, if ctrgj=0, wg,j,d is free, and hence is set to 0 due to Equation 20.

In one embodiment, a method of using a computing device to automatically assign offices to minimize a travel distance for employees includes receiving by a computing device identifications of a plurality of employees to assign an office within an office building; receiving a map of all offices withing the office building; receiving a team assignment of each of the plurality of employees; assigning by the computing device an office to each of the employees which minimizes distance between each employee on each team; and sending an electronic notification to each employee of the assigned office.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving input data for a plurality of entities and locations;
defining constraints for a group-based allocation model;
mapping a distance matrix to a plurality of distance levels to obtain a distance-level formulation;
defining a group-level objective function for the group-based allocation model;
applying the distance-level formulation to the group-level objective function;
solving the group-based allocation model to obtain a group-level assignment; and
mapping the group-level assignment to an entity-level assignment.

2. The computer-implemented method of claim 1, wherein the entities include employees.

3. The computer-implemented method of claim 1, wherein the locations include offices.

4. The computer-implemented method of claim 1, wherein the group-based allocation model is formulated at a group level instead of an entity level, thereby increasing a computational tractability of the group-based allocation model.

5. The computer-implemented method of claim 1, wherein the group-based allocation model incorporates a distance level, thereby reducing a number of quadratic terms within the group-based allocation model.

6. The computer-implemented method of claim 1, comprising:
modifying the constraints to the group-based allocation model;
adding constraints mapping groups to specific locations including offices, meeting rooms, and lab rooms to the group-based allocation model; and
adding constraints indicating entity-location eligibility constraints to the group-based allocation model.

7. The computer-implemented method of claim 1, comprising mapping a group-level solution to an entity-level solution.

8. The computer-implemented method of claim 1, comprising:
selecting a group center for each group; and
computing distances between locations utilizing the group center instead of pairwise distances between locations.

9. The computer-implemented method of claim 8, wherein a utilization of the group center increases a computational tractability of the group-based allocation model.

10. A computer program product comprising one or more computer readable storage media, and program instructions collectively stored on the one or more computer readable storage media, the program instructions comprising instructions configured to cause one or more processors to perform a method comprising:
receiving, by the one or more processors, input data for a plurality of entities and locations;
defining, by the one or more processors, constraints for a group-based allocation model;
mapping, by the one or more processors, a distance matrix to a plurality of distance levels to obtain a distance-level formulation;
defining, by the one or more processors, a group-level objective function for the group-based allocation model;
applying, by the one or more processors, the distance-level formulation to the group-level objective function;
solving, by the one or more processors, the group-based allocation model to obtain a group-level assignment; and
mapping, by the one or more processors, the group-level assignment to an entity-level assignment.

11. The computer program product of claim 10, wherein the entities include employees.

12. The computer program product of claim 10, wherein the locations include offices.

13. The computer program product of claim 10, wherein the group-based allocation model is formulated at a group level instead of an entity level, thereby increasing a computational tractability of the group-based allocation model.

14. The computer program product of claim 10, wherein the group-based allocation model incorporates a distance level, thereby reducing a number of quadratic terms within the group-based allocation model.

15. The computer program product of claim 10, comprising:
modifying the constraints to the group-based allocation model;
adding constraints mapping groups to specific locations including offices, meeting rooms, and lab rooms to the group-based allocation model; and
adding constraints indicating entity-location eligibility constraints to the group-based allocation model.

16. The computer program product of claim 10, comprising mapping a group-level solution to an entity-level solution.

17. The computer program product of claim 10, comprising:
selecting a group center for each group; and
computing distances between locations utilizing the group center instead of pairwise distances between locations.

18. The computer program product of claim 17, wherein a utilization of the group center increases a computational tractability of the group-based allocation model.

19. A system, comprising:
a processor; and
logic integrated with the processor, executable by the processor, or integrated with and executable by the processor, the logic being configured to:
receive input data for a plurality of entities and locations;
define constraints for a group-based allocation model;
map a distance matrix to a plurality of distance levels to obtain a distance-level formulation;
define a group-level objective function for the group-based allocation model;
apply the distance-level formulation to the group-level objective function;
solve the group-based allocation model to obtain a group-level assignment; and
map the group-level assignment to an entity-level assignment.

20. The system of claim 19, wherein the entities include employees, and the locations include offices.
